(19) United States
(12) Patent Application Publication
(10) Pub. No.: US 2024/0403637 A1
(43) Pub. Date: Dec. 5, 2024

(54) STORAGE MEDIUM STORED WITH MACHINE LEARNING PROGRAM, METHOD, AND DEVICE

(71) Applicants: Fujitsu Limited, Kawasaki-shi (JP); KYUSHU UNIVERSITY, NATIONAL UNIVERSITY CORPORATION, Fukuoka-shi (JP)

(72) Inventors: Hiroaki YAMADA, Kawasaki (JP); Shohei YAMANE, Kawasaki (JP); Naoyuki KAMIYAMA, Fukuoka (JP)

(73) Assignees: Fujitsu Limited, Kawasaki-shi (JP); KYUSHU UNIVERSITY, NATIONAL UNIVERSITY CORPORATION, Fukuoka-shi (JP)

(21) Appl. No.: 18/731,563

(22) Filed: Jun. 3, 2024

(30) Foreign Application Priority Data
Jun. 5, 2023 (JP) 2023-092781

(51) Int. Cl. G06N 3/08; G08G 1/01

(52) U.S. Cl. CPC G06N 3/08; G08G 1/0133; G08G 1/0145

(57) ABSTRACT

A machine learning device includes a processor that executes a procedure. The procedure includes: based on route information indicating movement conditions of a plurality of respective moving bodies in a specific geographical range at each of a plurality of time points, generating traffic flow information indicating a number of moving bodies located at respective route segments within the specific geographical range for each of the plurality of time points; and by using training data that includes the traffic flow information as input feature values and includes information indicating a degree of congestion of traffic in the specific geographical range at a time point corresponding to the traffic flow information as label information, training a machine learning model for deriving a degree of congestion of traffic corresponding to traffic flow information.

### CROSS-REFERENCE TO RELATED APPLICATION

This application is based upon and claims the benefit of priority of the prior Japanese Patent Application No. 2023-092781, filed on Jun. 5, 2023, the entire contents of which are incorporated herein by reference.

### FIELD

The embodiments discussed herein are related to a storage medium stored with a machine learning program, a machine learning method, and a machine learning device.

### BACKGROUND

Hitherto technology has been available that uses traffic simulations to optimize schedules and the like for public transport. For example, in cases in which a running schedule is to be decided for a special bus service for when an event is to be held, there is a need to avoid generating or worsening congestion and so departure times are set for the special bus to match traffic conditions. In such cases traffic simulations are employed to search for an optimum schedule that will not cause congestion.

Considerable effort is needed to build a traffic simulation device. Moreover, there is also a high computational load during simulation execution. On the other hand, a surrogate model for simulation with high accuracy can be built by extracting traffic demands and traffic densities from probe data, and training a relationship between the two using a machine learning model such as a neural network. Because a surrogate model has a lower computational load, the application range for optimizing tasks using simulations can be expanded. For example, application may be made even to optimization of daily schedules.

As a technology related to traffic simulations using a surrogate model, there is a proposal for a machine learning device that estimates people flows and traffic flows efficiently. In such a device, a first parameter representing an environment and a second parameter representing an attribute of movement in the environment by plural respective moving bodies are acquired, and the plural moving bodies are then classified into plural groups based on the second parameter. Moreover in such a device, a third parameter is generated to indicate the number of the moving bodies classified into the plural respective groups, the first parameter and the third parameter are input to a machine learning model, and estimation information related to the movement in the environment of the plural moving bodies is generated.

### RELATED DOCUMENTS

### Related Patent Documents

Japanese Patent Application Laid-Open (JP-A) No. 2022-131393

### SUMMARY

According to an aspect of the embodiments, a non-transitory recording medium storing a program that causes a computer to execute a machine learning process including: based on route information indicating movement conditions of plural respective moving bodies in a specific geographical range at each of plural time points, generating traffic flow information indicating a number of moving bodies located at respective route segments within the specific geographical range for each of the plural time points; and by using training data that includes the traffic flow information as input feature values and includes information indicating a degree of congestion of traffic in the specific geographical range at a time point corresponding to the traffic flow information as label information, training a machine learning model for deriving a degree of congestion of traffic corresponding to traffic flow information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram to explain a traffic simulation.

FIG. 2 is a schematic diagram illustrating an example of a road network.

FIG. 3 is a diagram to explain a machine learning phase of a surrogate model.

FIG. 4 is a diagram to explain an optimization phase using a surrogate model.

FIG. 5 is a diagram to explain an issue when using feature values of an origin-destination (OD) matrix representation.

FIG. 6 is a functional block diagram of a machine learning device according to an exemplary embodiment.

FIG. 7 is a diagram to explain generation of traffic flow information.

FIG. 8 is a diagram to explain conversion of probe data into link series.

FIG. 9 is a diagram illustrating an example of traffic flow information of link series aggregated by each time.

FIG. 10 is a diagram illustrating an example of traffic flow information of link series aggregated by departure time.

FIG. 11 is a diagram to explain feature values when using an OD matrix representation.

FIG. 12 is a diagram to explain feature values in the present exemplary embodiment.

FIG. 13 is a diagram to explain generation of route information based on OD predicted values and supplementary information.

FIG. 14 is a block diagram illustrating a schematic configuration of a computer that functions as a machine learning device.

FIG. 15 is a flowchart illustrating an example of machine learning processing.

FIG. 16 is a flowchart illustrating an example of optimization processing.

### DESCRIPTION OF EMBODIMENTS

Description follows regarding an example of exemplary embodiments according to technology disclosed herein, with reference to the drawings.

### Traffic Simulation and Surrogate Models: Outline and Issues

Prior to describing details of the exemplary embodiments, traffic simulations and surrogate models in general will first be described, together with some of the issues that arise therewith.

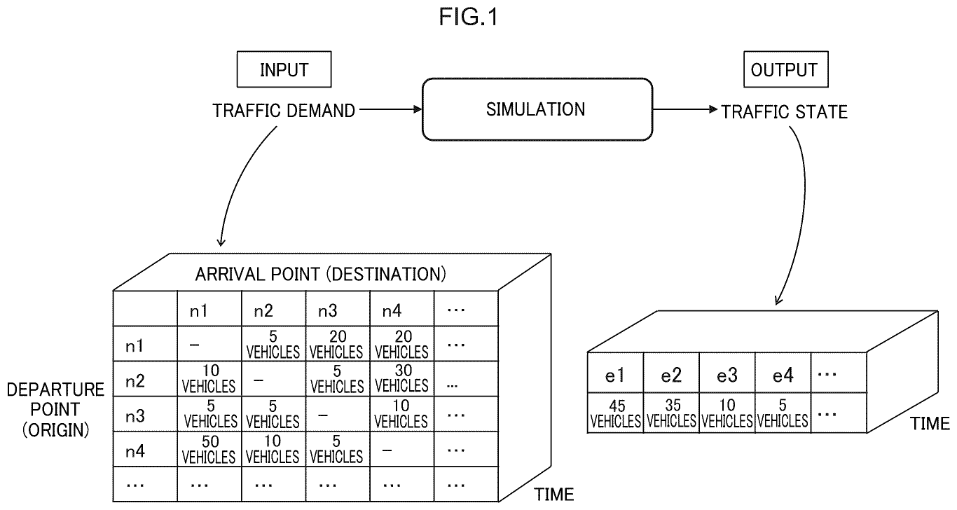

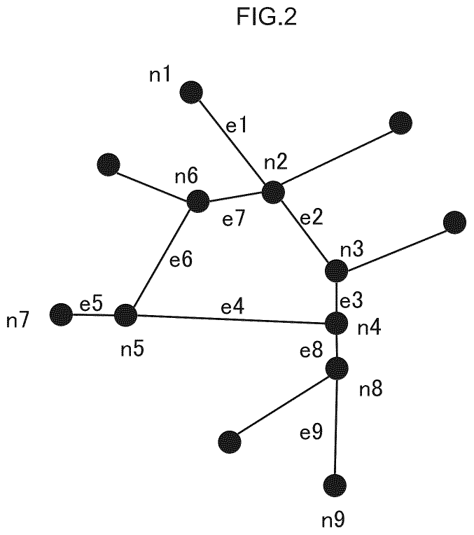

As illustrated in FIG. 1, a traffic simulation is input with traffic demands, and simulates and outputs traffic states corresponding to these traffic demands. For example, as illustrated in FIG. 2, a traffic simulation is performed using a road network expressed by plural nodes and links connecting between nodes. In the example of FIG. 2, nodes are represented by black circles and links are represented by connecting lines that connect between the nodes. Moreover, node identification numbers “ni (i=1, 2, . . . )” are written alongside the nodes, and link identification numbers “ej (j=1, 2, . . . )” are written alongside the links. In the following a node of identification number ni is indicated by “node ni”, and a link of identification number ej is indicated by “link ej”. There are also cases in which the links are notated by connecting the node numbers of the nodes at the two ends of the link. For example, the link e1 is notated by “n1-n2”. Note that a link is an example of a “route segment” of technology disclosed herein.

The traffic demand is, for example, represented by an OD matrix indicating a number of moving bodies (people, vehicles, and the like) that have moved between each ground point (node). The OD matrix is a matrix representation of nodes at departure points (origins) and nodes at arrival points (destinations), and is a representation in which the numbers of moving bodies that move from a departure point to an arrival point corresponding to each respective cell in the matrix are stored in that cell. Moreover, ODs by time band may be used to give a three-dimensional tensor as illustrated in FIG. 1 as traffic demand. Moreover, a traffic state is, for example, a traffic density expressed as a traffic volume for each link.

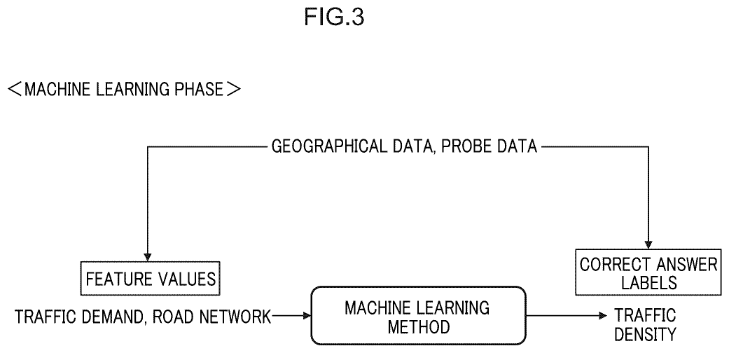

A machine learning model (surrogate model) for traffic simulation is a lightweight surrogate model to reproduce input/output relationships of traffic simulation such as illustrated in FIG. 1. As illustrated in FIG. 3, in a machine learning phase of a machine learning model, an information processing device takes geographical data and plural probe data, and extracts traffic demand and a road network serving as feature values therefrom, and also extracts traffic densities that serve as correct answer labels. The probe data is data recorded with location information (latitude and longitude or the like) for each moving body together with time stamps. The probe data is acquired using smartphones, various sensors and the like, and is collected over a network. Geographical data is data in which various geographical information, including road network information, are recorded.

The information processing device then inputs the extracted traffic demands and road network as feature values into the machine learning model configured by a neural network or the like, and acquires traffic densities inferred by the machine learning model. The information processing device then trains the machine learning model by updating the parameters of the machine learning model so as to minimize errors between the acquired traffic densities and the traffic densities that are the correct answer labels.

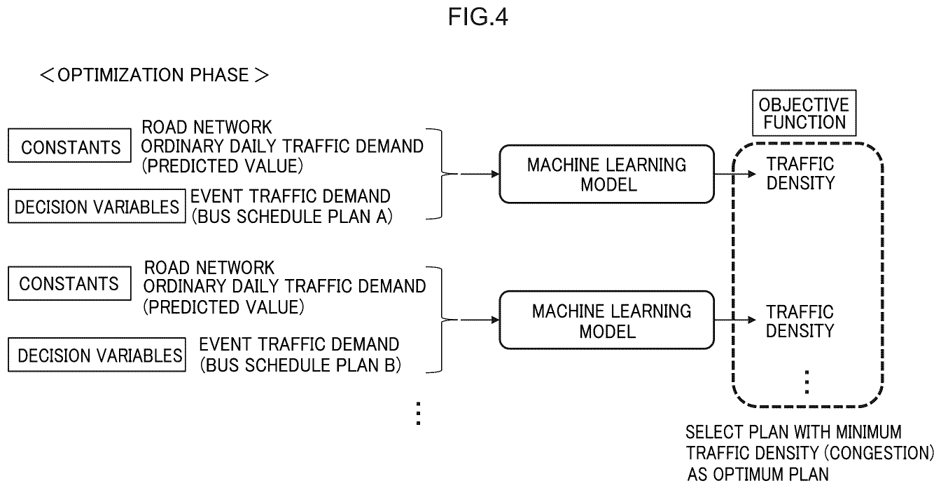

In the optimization phase using the trained machine learning model as illustrated in FIG. 4, the information processing device inputs the road network and the traffic demands into the machine learning model, and acquires the traffic densities that are the objective function. FIG. 4 illustrates an example of optimizing a running schedule for busses when an event is being held. In the example illustrated in FIG. 4, the information processing device inputs the machine learning model with the road network and predicted values of ordinary traffic demand as constants, and with event traffic demand for each bus running schedule plan as decision variables. Note that the road network may also be treated as a decision variable. The information processing device then compares the traffic densities obtained for each plan, and selects the plan with the minimum traffic density (congestion) for output as the optimum plan. Note that optimization may be executed by any suitable existing method, such as using a genetic algorithm or the like.

In cases in which, as described above, feature values expressed in an OD matrix are employed as the feature values for use in training the traffic simulation machine learning model (surrogate model), sometimes a condition arises in which multiple traffic states are unable to be appropriately discriminated, and training of the machine learning model is not able to progress smoothly.

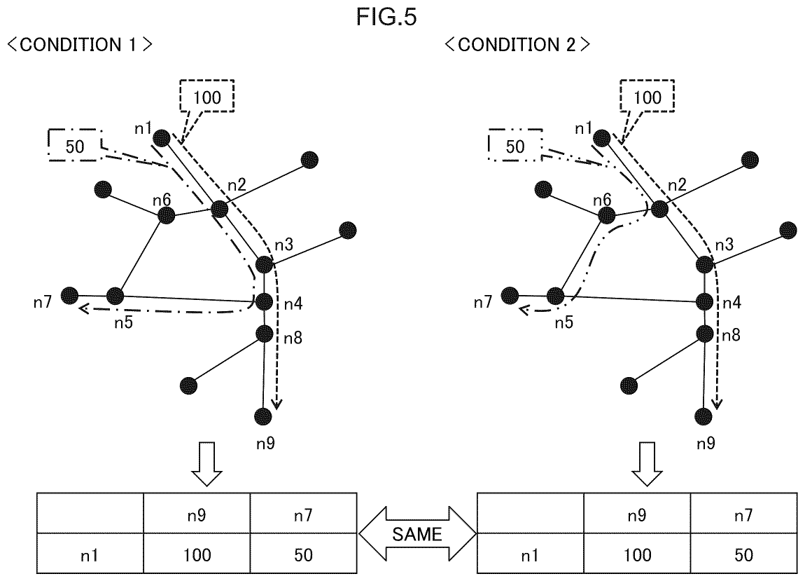

For example, consider the condition 1 and the condition 2 as illustrated in FIG. 5. In the condition 1, there are 100 instances of probe data indicating route 1 (indicated by the broken line arrow in FIG. 5) of nodes n1→n2→n3→n4→n8→n9, and there are 50 instances of probe data indicating route 2 (indicated by the single-dot broken line arrow in FIG. 5) of nodes n1→n2→n3→n4→n5→n7. Moreover, in the condition 2, there are 100 instances of probe data indicating route 1 similarly to in the condition 1, and there are 50 instances of probe data indicating route 3 (indicated by the double-dot broken line arrow in FIG. 5) of nodes n1→n2→n6→n5→n7. When each of these conditions is expressed as an OD matrix, as illustrated at the bottom of FIG. 5, this results in the same OD matrix irrespective of the fact that condition 1 and condition 2 are actually different conditions. Namely, discrimination between these two conditions is unable to be performed in cases in which the machine learning model is trained using this OD matrix as the feature values, and a machine learning model is unable to be built with high accuracy.

To address this, conceivably more conditions could be discriminated by utilizing route information. However, were route information for each moving body to be employed as is as a feature value then this would result in the number of dimensions of the feature values being too high. The route information for each moving body is node series data indicating movement routes of the moving bodies, such as n1→n2→ . . . , as described above. The route information is not limited to being node series data, and may be link series data, and may be location information (latitude and longitude) series data. In cases in which the route information is employed as is as the feature values, the number of dimensions of the feature values is, for example, a vast number of dimensions resulting from the number of nodes contained in the route information (several hundred) being multiplied by the number of moving bodies (several tens of thousands to several million).

To address this issue in the present exemplary embodiment, information resulting from abbreviating the route information for each moving body, specifically information about the number of moving bodies passing through each link (link traffic flow) is employed to featurize traffic demand with an expression method capable of discriminating multiple traffic states. The number of dimensions of the feature values in such cases is, for example, of the order of the number of links (several thousand) multiplied by the number of time slots (several tens). In the present exemplary embodiment a traffic demand expression method capable of discriminating between multiple traffic states is employed to build a machine learning model for high accuracy traffic simulation.

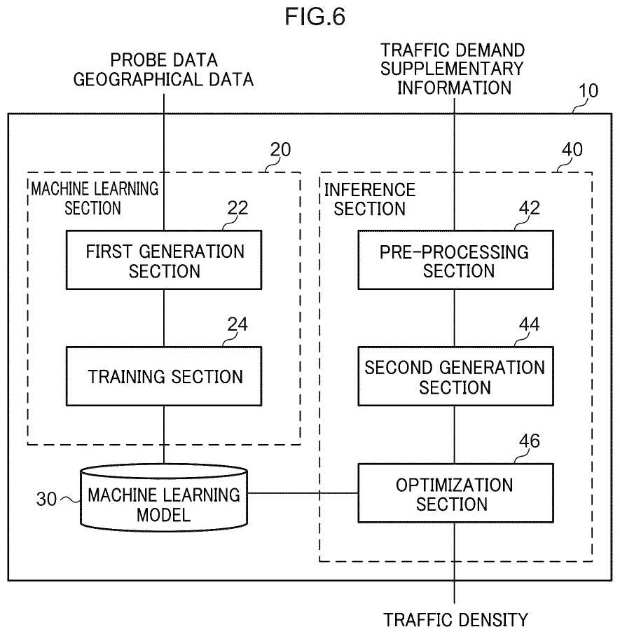

Machine Learning Device According to Present Exemplary Embodiment As illustrated in FIG. 6, the machine learning device 10 according to the present exemplary embodiment includes a machine learning section 20, and an inference section 40. Moreover, a machine learning model 30 that is a traffic simulation surrogate model is stored in a specific storage area of the machine learning device 10. The machine learning model 30 is, for example, configured by a neural network or the like.

The machine learning section 20 is a functional section that functions in the machine learning phase. In the machine learning phase the machine learning device 10 is input with plural probe data and geographical data. The machine learning section 20 includes a first generation section 22 and a training section 24.

The first generation section 22 acquires the plural probe data and geographical data that were input to the machine learning device 10. Based on route information indicating a movement condition for the plural respective moving bodies in a specific geographical range at each of plural time points, the first generation section 22 generates traffic flow information indicating the number of moving bodies located at each of the links within the specific geographical range at each of the plural time points. The specific geographical range is an area indicated by a road network included in the geographical data.

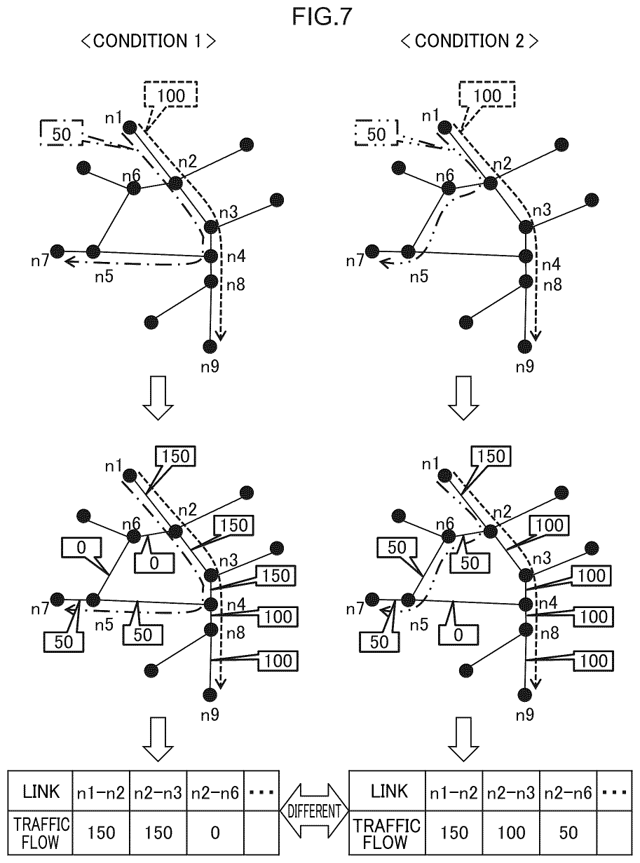

More specifically as illustrated in FIG. 7, the first generation section 22 tallies the traffic flow at each link of the road network based on the route information indicated by the plural probe data, and generates traffic flow information therefrom. This thereby enables the generation of feature values in which respective conditions are discriminated between even in conditions in which the feature values would be the same in an OD matrix representation, as is the case with the condition 1 and the condition 2 illustrated in FIG. 5.

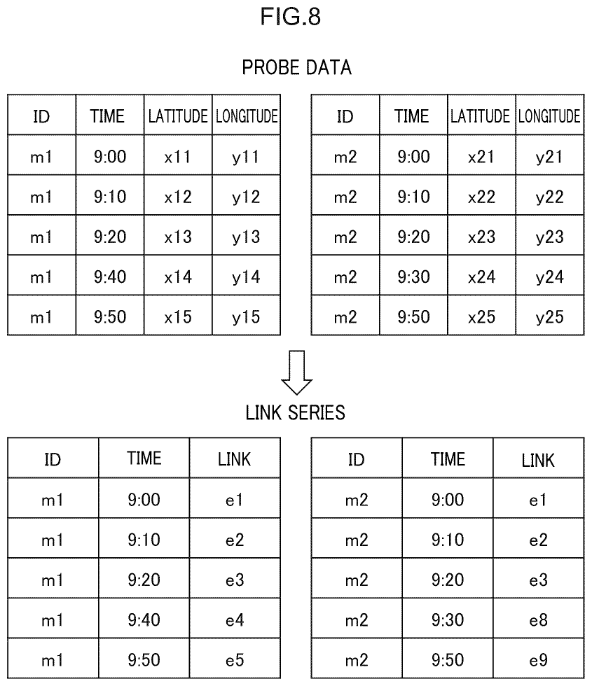

More specifically, the first generation section 22 shapes the probe data. For example, in cases in which, as illustrated at the top of FIG. 8, a measurement interval (interval of the “time” item) is unable to be standardized in probe data expressed in a data format of {ID (moving body identification information), time, latitude, longitude}, the first generation section 22 may perform interpolation so as to standardize the time intervals. For example, the first generation section 22 may perform interpolation such that the probe data is data at one minute intervals.

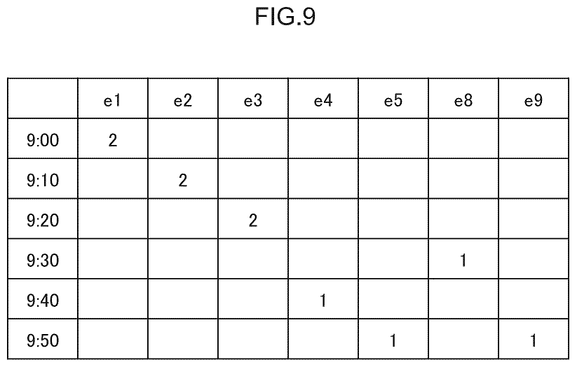

The first generation section 22 associates the probe data after shaping with the road network, and compares the location information (latitude and longitude) of moving bodies against the location information of each link. Then as illustrated at the bottom of FIG. 8, the first generation section 22 converts the probe data into series data of links where each moving bodies is present at each time (hereafter called “link series”). Based on the link series for each of the moving bodies as converted from the probe data, the first generation section 22 aggregates the number of moving bodies present at each link for each time, and generates traffic flow information. FIG. 9 illustrates traffic flow information resulting from aggregating the link series illustrated at the bottom of FIG. 8.

Probe data contains, for example, the effects of delays from traffic lights, delays due to congestion, and the like. Preferably these effects are removed in feature values to be employed to train the machine learning model 30. This is because it would be unthinkable to, when performing inference, be given traffic demands that contain the effects of delays from traffic lights, delays due to congestion, and the like, namely the effects of interactions between moving bodies or interactions with the road network. After all, a traffic simulation aims to simulate traffic states that take into consideration of the effects of delays and the like from traffic demands that have had effects due to such delays removed and that correspond to pre-planned routes. This means that, as described above, it is preferable that the effects of delays and the like are not contained in feature values employed to train the machine learning model 30.

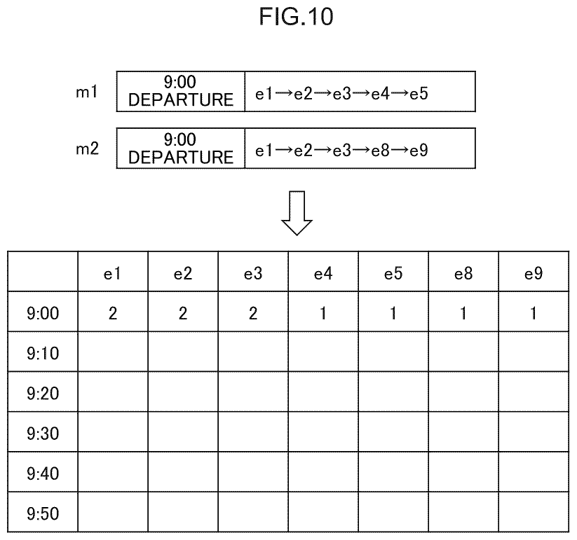

The first generation section 22 may accordingly create traffic flow information from which information of the time during movement has been removed. More specifically, the first generation section 22 associates the link series of each moving body with times corresponding to the departure points of the link series, as illustrated at the top of FIG. 10. Then the first generation section 22 generates traffic flow information in which the link series associated with times corresponding to the departure points have been aggregated, as illustrated at the bottom of FIG. 10. This means that traffic flow information corresponding to the pre-planned routes is generated with the effects of delays from traffic lights, delays due to congestion, and the like excluded therefrom.

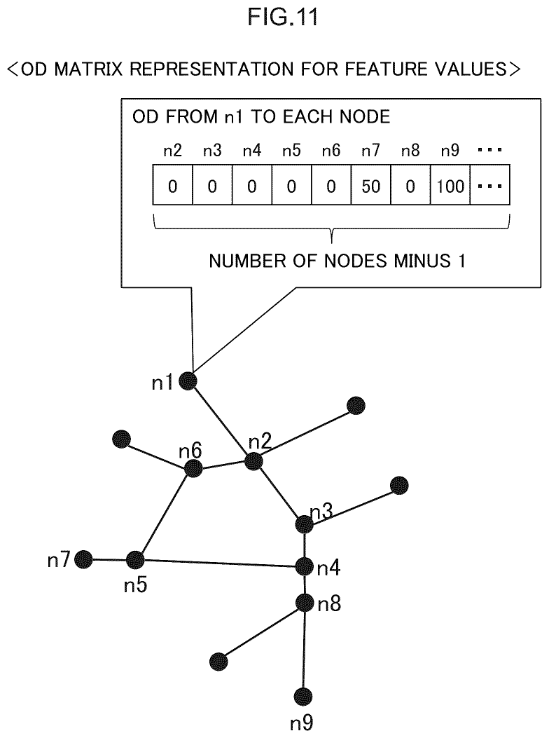

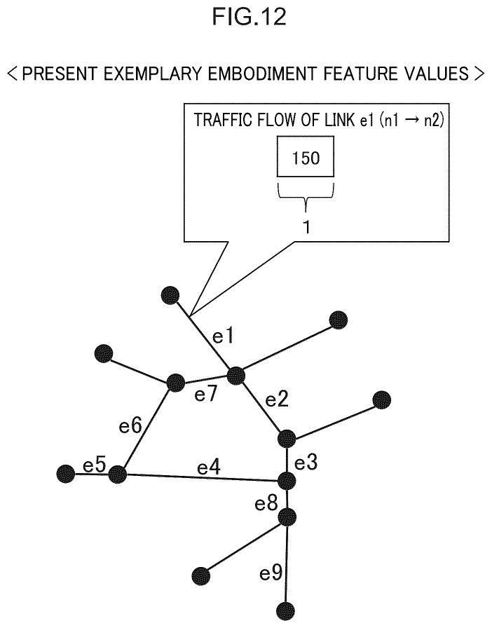

In this manner, the traffic flow information that is the feature values generated in the first generation section 22 becomes feature values of links configuring the road network. For example, in cases in which feature values expressed as an OD matrix are employed, as illustrated in FIG. 11, for each node, each node holds information about the number of items of route information having this node as the departure point and another respective node as the arrival point. Namely, each node holds a number of items worth of information that is the number of nodes contained in the road network minus 1 item. In contrast thereto, for the feature values of the present exemplary embodiment, as illustrated in FIG. 12, each link holds 1 item of information of the traffic flow for the link.

Moreover, based on the probe data, the first generation section 22 generates information indicating the degree of congestion of traffic in the specific geographical range at the time point corresponding to the traffic flow information as the correct answer labels for traffic density. For example, the first generation section 22 generates a link traffic flow representing the number of moving bodies present at each link at each time as the correct answer label for traffic density.

The training section 24 uses the traffic flow information generated by the first generation section 22 as the input feature values, and training data including input feature values and correct answer labels for traffic density, to train the machine learning model 30 to derive a degree of congestion of traffic corresponding to the traffic flow information. Specifically, the training section 24 inputs the machine learning model 30 with feature values of the generated traffic flow information, and acquires a traffic density inferred by the machine learning model 30. The training section 24 then trains the machine learning model 30 by updating the parameters of the machine learning model 30 so as to minimize errors between the acquired traffic densities and the traffic densities generated as the correct answer labels.

The inference section 40 is a functional section that functions in the optimization phase. In the optimization phase, the machine learning device 10 is input with supplementary information (described in detail later) that is at least one out of traffic demands, traffic flows of partial route segments, or domain knowledge related to movement conditions of moving bodies. The inference section 40 includes a pre-processing section 42, a second generation section 44, and an optimization section 46.

In the present exemplary embodiment, the feature values for input to the machine learning model 30 are traffic flow information such as illustrated at the bottom of FIG. 9 and FIG. 10. The traffic flow information is generated by aggregating the route information of the moving bodies. However, in many cases probe data such as that of the machine learning phase is not obtainable in the optimization phase, and only OD predicted values are obtained as the traffic demand. Moreover depending on the case, sometimes estimated values of partial link traffic flow may be given. Furthermore, as a fundamental principle for route selection, sometimes domain knowledge related to the movement conditions of moving bodies, such as road distance information, OD type information, traffic charge information, information regarding driver behavior trends, or the like may be utilizable. Such estimated values of partial link traffic flows and domain knowledge are collectively referred to as “supplementary information”.

When presented with traffic demands for each of plural combinations of departure point and arrival point, namely with OD predicted values, the pre-processing section 42 generates route information by distributing each of the plural combinations across plural routes. Moreover, when presented with supplementary information in addition to the OD predicted values, the pre-processing section 42 distributes the respective plural combinations across plural routes based on the supplementary information.

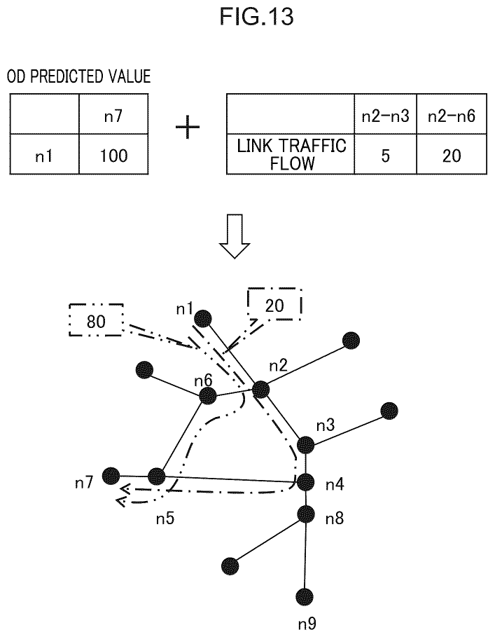

For example, as illustrated at the top of FIG. 13, consider a case in which OD predicted values are given for a route having a departure point of node n1, an arrival point of node n7, and with link traffic flow of links n2-n3 and n2-n6. Furthermore, as illustrated at the bottom of FIG. 13, consider a case in which the following routes satisfy this OD: route 1 (indicated by the broken line arrow) of node n1→n2→n3→n4→n5→n7, and route 2 (indicated by the single-dot broken line arrow) of node n1→n2→n6→n5→n7. In such a case the pre-processing section 42 distributes the OD predicted values between route 1 and route 2 based on a ratio of link traffic flow between the links where the two routes branch. In the example in FIG. 13, the pre-processing section 42 distributes the OD predicted value 100 for n1→n7 at a ratio of route 1:route 2=20:80 based on the ratio (5:20) of link traffic flow at link n2-n3 to at link n2-n6. The pre-processing section 42 thereby generates route information from the OD predicted values and the estimated values of the partial link traffic flow.

Note that in cases in which the estimated value of the partial link traffic flow is not able to be obtained, the route information may be generated by distributing the OD predicted values either uniformly or randomly across any routes satisfying the OD. Moreover, distribution may be performed using domain knowledge. For example, based on domain knowledge of “people will select the route that minimizes travel time”, the route information may be generated with the OD predicted values distributed to the route that minimizes the travel time from out of any routes satisfying the OD. Moreover, for example, in cases in which the OD predicted values are those of a time band in the middle of the night, this OD may be taken as being the OD of a distribution truck, and domain knowledge “distribution trucks tend to prioritize the shortest time even if this incurs a charge of some kind” may be utilized. Moreover, in cases in which the OD predicted value is for a time band during the daytime, this OD may be taken as being the OD of a car, and domain knowledge of “cars tend to priorities low charges over shorter time” may be utilized.

In cases in which there are plural items of domain knowledge that can be utilized, the distribution to each route may be decided by an appropriate combination of these items of domain knowledge. As the number of utilizable items of domain knowledge increases, route information that better fits reality can be generated from the given OD predicted values. Namely, as the number of utilizable items of domain knowledge increases, the number of discriminable traffic states increases, and the accuracy of inference by the machine learning model 30 also improves.

The second generation section 44 employs the route information generated in the pre-processing section 42 to generate link series from the route information similarly to the first generation section 22, aggregates the link series by link by each time or departure time, and generates traffic flow information serving as feature values for inputting to the machine learning model 30.

The optimization section 46 estimates a traffic density by inputting the traffic flow information generated by the second generation section 44 into the machine learning model 30. The optimization section 46 estimates the traffic densities for each of the traffic demands corresponding to a plan such as a schedule subject to simulation, and selects and outputs the plan giving the minimum traffic density as the optimum plan.

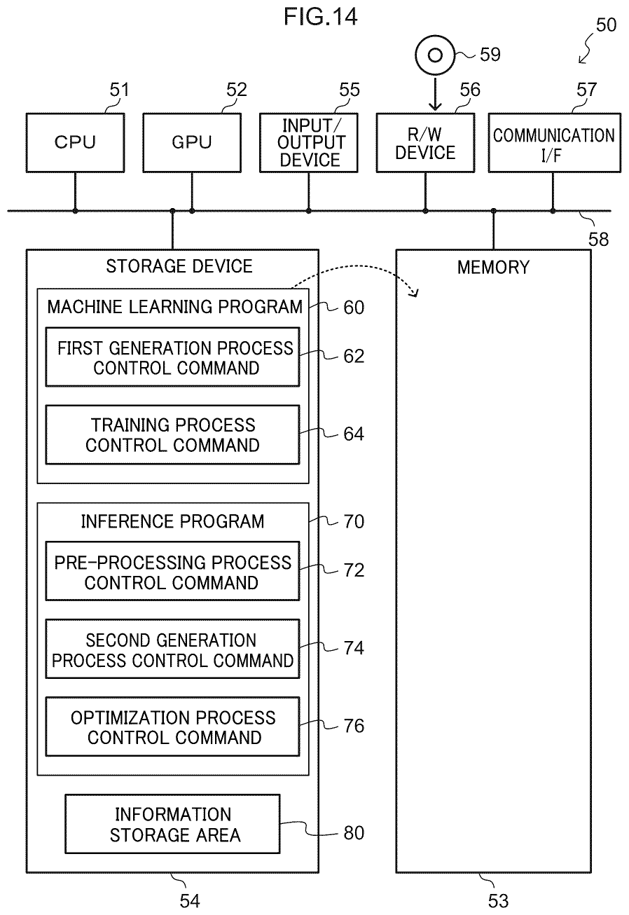

The machine learning device 10 may, for example, be implemented by a computer 50 as illustrated in FIG. 14. The computer 50 includes a central processing unit (CPU) 51, a graphics processing unit (GPU) 52, memory 53 serving as a non-transitory storage area, and a non-volatile storage device 54. The computer 50 also includes an input/output device 55 such as an input device, display device, and the like, and a read/write R/W device 56 to control reading of data from a storage medium 59 and writing of data thereto. The computer 50 also includes a communication interface (I/F) 57 connected to a network such as the internet. The CPU 51, the GPU 52, the memory 53, the storage device 54, the input/output device 55, the R/W device 56, and the communication I/F 57 are connected to each other through a bus 58.

The storage device 54 is, for example, a hard disk drive (HDD), solid state drive (SSD), flash memory, or the like. A machine learning program 60 that causes the computer 50 to function as the machine learning section 20, and an inference program 70 that causes the computer 50 to function as the inference section 40 are stored on the storage device 54 serving as a storage medium. The machine learning program 60 includes a first generation process control command 62 and a training process control command 64. The inference program 70 includes a pre-processing process control command 72, a second generation process control command 74, and an optimization process control command 76. The storage device 54 includes an information storage area 80 where information configuring the machine learning model 30 is stored.

The CPU 51 reads the machine learning program 60 from the storage device 54, expands the machine learning program 60 in the memory 53, and sequentially executes control commands contained in the machine learning program 60. The CPU 51 operates as the first generation section 22 illustrated in FIG. 6 by executing the first generation process control command 62. The CPU 51 operates as the training section 24 illustrated in FIG. 6 by executing the training process control command 64. The CPU 51 reads information from the information storage area 80 and expands the machine learning model 30 into the memory 53. The computer 50 that has executed the machine learning program 60 accordingly functions as the machine learning section 20 of the machine learning device 10.

The CPU 51 reads the inference program 70 from the storage device 54, expands the inference program 70 in the memory 53, and sequentially executes control commands contained in the inference program 70. The CPU 51 operates as the pre-processing section 42 illustrated in FIG. 6 by executing the pre-processing process control command 72. The CPU 51 operates as the second generation section 44 illustrated in FIG. 6 by executing the second generation process control command 74. The CPU 51 operates as the optimization section 46 illustrated in FIG. 6 by executing the optimization process control command 76. The CPU 51 reads information from the information storage area 80 and expands the machine learning model 30 into the memory 53. The computer 50 that has executed the inference program 70 accordingly functions as the inference section 40 of the machine learning device 10.

Note that the CPU 51 to execute the programs is hardware. Moreover, part of the programs may be executed by the GPU 52.

Moreover, the functions implemented by the machine learning program 60 and the inference program 70 may be implemented by, for example, a semiconductor integrated circuit, and more specifically by an application specific integrated circuit (ASIC), field programmable gate array (FPGA), or the like.

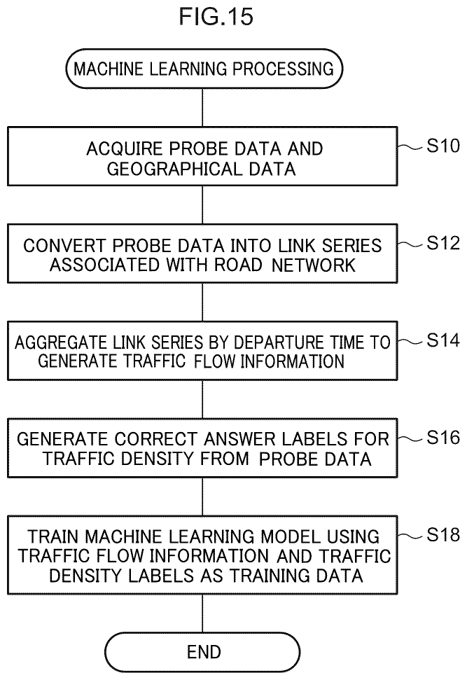

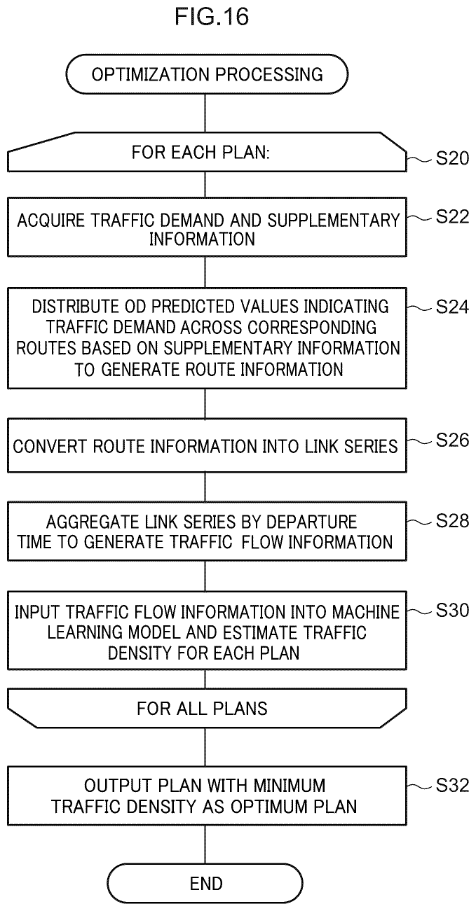

Next, description follows regarding operation of the machine learning device 10 according to the present exemplary embodiment. In the machine learning phase, when the plural probe data and the geographical data is input to the machine learning device 10, the machine learning processing illustrated in FIG. 15 is executed in the machine learning device 10. Moreover, in the optimization phase, when the traffic demands and the supplementary information is input to the machine learning device 10, the optimization processing illustrated in FIG. 16 is executed in the machine learning device 10. Note that the machine learning processing is an example of a machine learning method of technology disclosed herein. Detailed explanation follows regarding the machine learning processing and the optimization processing.

First description follows regarding the machine learning processing illustrated in FIG. 15.

At step S10, the first generation section 22 acquires the plural probe data and the geographical data that has been input to the machine learning device 10. Next, at step S12, the first generation section 22 associates the probe data with the road network, and converts the probe data into link series.

Next, at step S14, the first generation section 22 aggregates all of the links contained in the link series for each of the moving bodies by the times corresponding to the departure points of the link series, and generates the traffic flow information by counting the moving bodies present at each of the links at each of the aggregated times. Next at step S16, the first generation section 22 generates, from the probe data, link traffic flows expressed by the number of moving bodies present at each of the links at each of the times and correct answer labels for traffic densities.

Next, at the step S18, the training section 24 trains the machine learning model 30 using, as training data, the traffic flow information generated at step S14 as feature values, together with the correct answer labels generated at step S16. The training section 24 stores the trained machine learning model 30 in the specific storage area and ends the machine learning processing.

Next, description follows regarding the optimization processing illustrated in FIG. 16.

A processing loop of step S20 is executed for each plan, such as schedule or the like, that is to be subjected to traffic simulation execution. Specifically, at step S22 the pre-processing section 42 acquires the OD predicted values that are the traffic demands and the supplementary information input to the machine learning device 10. Next, at step S24, based on the OD predicted values and the supplementary information, the pre-processing section 42 generates the route information by distribution across routes corresponding to this OD.

Next, at step S26, the second generation section 44 converts the route information into link series. Next, at step S28, the second generation section 44 aggregates all of the links contained in the link series for each of the moving bodies by the times corresponding to the departure points of the link series, and generates the traffic flow information by counting the moving bodies present at each of the links for the aggregated times.

Next, at step S30, the optimization section 46 estimates the traffic density by inputting the traffic flow information generated at step S28 into the machine learning model 30. When the processing of step S22 to step S30 has been completed for all of the plans, the processing loop of step S20 is ended, and processing transitions to step S32.

At step S32, the optimization section 46 selects and outputs the plan with the minimum estimated traffic density from out of the plans as the optimum plan, and ends the optimization processing.

As described above, the machine learning device according to the present exemplary embodiment generates the traffic flow information illustrating the number of moving bodies located at each respective link inside the road network at each of plural time points based on the probe data of the plural respective moving bodies in the specific geographical range. The machine learning device trains the machine learning model to derive a traffic density corresponding to traffic flow information by using training data of the traffic flow information as input feature values, and the traffic density at the time points corresponding to the traffic flow information as label information. This accordingly enables a machine learning model to be built for high accuracy traffic simulation using a method expressing multiple traffic states as discriminable traffic demands.

Note that although the above machine learning processing and optimization processing have been described for a case in which traffic flow information generated from the link series aggregated by departure times is employed as feature values, traffic flow information aggregating link series by time, such as illustrated in FIG. 9, may be employed as the feature values.

Moreover, although the above exemplary embodiment have been described for a case in which the machine learning section and the inference section are configured by the same computer, these may each be configured by a separate computer.

Moreover, although in the above exemplary embodiment the machine learning program and the inference program are pre-stored (installed) on the storage device, there is no limitation thereto. The programs according to the technology disclosed herein may be provided in a format stored on a storage medium such as a CD-ROM, DVD-ROM, USB memory, or the like.

When training a traffic simulation surrogate model, generally the training data employed is traffic demands expressed by an origin-destination (OD) matrix as the feature values and traffic densities as the correct answer labels. However for feature values expressed as an OD matrix, sometimes a condition arises in which multiple traffic states are unable to be appropriately discriminated, and training of the surrogate model is not able to progress smoothly.

The technology disclosed herein uses a method expressing multiple traffic states as discriminable traffic demand, and enables a machine learning model to be built for high accuracy traffic simulation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program that is executable by a computer to perform a machine learning process comprising:
based on route information indicating movement conditions of a plurality of respective moving bodies in a specific geographical range at each of a plurality of time points, generating traffic flow information indicating a number of moving bodies located at respective route segments within the specific geographical range for each of the plurality of time points; and
by using training data that includes the traffic flow information as input feature values and includes information indicating a degree of congestion of traffic in the specific geographical range at a time point corresponding to the traffic flow information as label information, training a machine learning model for deriving a degree of congestion of traffic corresponding to traffic flow information.

2. The non-transitory recording medium of claim 1, wherein generating the traffic flow information includes, based on location information of the moving bodies at each time point contained in the route information as location information of a time point corresponding to a departure point contained in the route information and based on one or more item of the route information having the same time point corresponding to the departure point, tallying for each of the route segments a number of instances of the route information that include location information corresponding to the same route segment.

3. The non-transitory recording medium of claim 1, the machine learning processing further comprising:
inputting traffic flow information of an inference target into a trained machine learning model and inferring a degree of congestion of traffic corresponding to the traffic flow information of the inference target.

4. The non-transitory recording medium of claim 3, wherein:
in a case in which traffic demands have been given for a plurality of respective combinations of a departure point and an arrival point, the trained machine learning model is input with traffic flow information generated based on route information generated by distributing the plurality of respective combinations across a plurality of routes, as the traffic flow information of the inference target.

5. The non-transitory recording medium of claim 4, wherein the plurality of respective combinations is distributed across the plurality of routes based on supplementary information that is at least one of a traffic flow of a partial route segment or domain knowledge related to a movement condition of a moving body.

6. A machine learning method comprising:
based on route information indicating movement conditions of a plurality of respective moving bodies in a specific geographical range at each of a plurality of time points, generating traffic flow information indicating a number of moving bodies located at respective route segments within the specific geographical range for each of the plurality of time points; and
by a processor, using training data that includes the traffic flow information as input feature values and includes information indicating a degree of congestion of traffic in the specific geographical range at a time point corresponding to the traffic flow information as label information, training a machine learning model for deriving a degree of congestion of traffic corresponding to traffic flow information.

7. The machine learning method of claim 6, wherein:
generating the traffic flow information includes, based on location information of the moving bodies at each time point contained in the route information as location information of a time point corresponding to a departure point contained in the route information and based on one or more item of the route information having the same time point corresponding to the departure point, tallying for each of the route segments a number of instances of the route information that include location information corresponding to the same route segment.

8. The machine learning method of claim 6, further comprising:
inputting traffic flow information of an inference target into a trained machine learning model and inferring a degree of congestion of traffic corresponding to the traffic flow information of the inference target.

9. The machine learning method of claim 8, wherein:
in a case in which traffic demands have been given for a plurality of respective combinations of a departure point and an arrival point, the trained machine learning model is input with traffic flow information generated based on route information generated by distributing the plurality of respective combinations across a plurality of routes, as the traffic flow information of the inference target.

10. The machine learning method of claim 9, wherein:
the plurality of respective combinations is distributed across the plurality of routes based on supplementary information that is at least one of a traffic flow of a partial route segment or domain knowledge related to a movement condition of a moving body.

11. A machine learning device comprising:
a memory, and
a processor coupled to the memory, the processor being configured to execute processing, the processing including:
based on route information indicating movement conditions of a plurality of respective moving bodies in a specific geographical range at each of a plurality of time points, generating traffic flow information indicating a number of moving bodies located at respective route segments within the specific geographical range for each of the plurality of time points; and
by using training data that includes the traffic flow information as input feature values and includes information indicating a degree of congestion of traffic in the specific geographical range at a time point corresponding to the traffic flow information as label information, training a machine learning model for deriving a degree of congestion of traffic corresponding to traffic flow information.

12. The machine learning device of claim 11, wherein:
generating the traffic flow information includes, based on location information of the moving bodies at each time point contained in the route information as location information of a time point corresponding to a departure point contained in the route information and based on one or more item of the route information having the same time point corresponding to the departure point, tallying for each of the route segments a number of instances of the route information that include location information corresponding to the same route segment.

13. The machine learning device of claim 11, the processing further comprising:
inputting traffic flow information of an inference target into a trained machine learning model and inferring a degree of congestion of traffic corresponding to the traffic flow information of the inference target.

14. The machine learning device of claim 13, wherein
in a case in which traffic demands have been given for a plurality of respective combinations of a departure point and an arrival point, the trained machine learning model is input with traffic flow information generated based on route information generated by distributing the plurality of respective combinations across a plurality of routes, as the traffic flow information of the inference target.

15. The machine learning device of claim 14, wherein:
the plurality of respective combinations is distributed across the plurality of routes based on supplementary information that is at least one of a traffic flow of a partial route segment or domain knowledge related to a movement condition of a moving body.
